(19) United States
(12) Patent Application Publication
(10) Pub. No.: US 2013/0338811 A1
(43) Pub. Date: Dec. 19, 2013

(54) MATRIX PRODUCTION SYSTEM AND CONTROL METHOD THEREOF

(71) Applicants: HON HAI PRECISION INDUSTRY CO., LTD., New Taipei (TW); Fu Tai Hua Industry (Shenzhen) Co., Ltd., Shenzhen (CN)

(72) Inventors: HUAN-HUAN ZHANG, Shenzhen (CN); YU-YONG ZHANG, Shenzhen (CN); XUE-SHUN LIU, Shenzhen (CN); XIN LU, Shenzhen (CN); SHIH-FANG WONG, New Taipei (TW)

(21) Appl. No.: 13/920,193

(22) Filed: Jun. 18, 2013

(30) Foreign Application Priority Data
Jun. 19, 2012 (CN) 201210202757X

(51) Int. Cl. G05B 19/418

(52) U.S. Cl. CPC G05B 19/4184
USPC 700/111

(57) ABSTRACT

A matrix production system for a production line includes a plurality of processing units, a controller, and a plurality of detectors. Each processing unit covers a plurality of stations having the same or similar functions. Each station has a detector. The controller sets an initial flowchart during process of industrial production and a known first reference capacity for each station. A current number of workpieces at each station is detected. The controller compares the current number with the first reference capacity to determine an overburdened station or otherwise and then analyzes a running state of overburdened station determined as being overburdened to establish a malfunctioning station, and if malfunctioning, switches the flow of workpieces from the malfunctioning station to a station with the greatest amount of available or free capacity.

### BACKGROUND

1. Technical Field

The present disclosure relates to a system for controlling the functioning of production lines, and particularly to a control method for a matrix production system.

2. Description of Related Art

Production lines add parts to a product in a sequential manner to create a finished product. In a factory, a plurality of substantially similar production lines may be set to produce the same products. A production line may include a plurality of stations to complete different procedures. However, when one of the stations of a production line is overburdened or malfunctioning, production speed of this production line may be slowed down. Additionally, at this time, the same stations of other production lines may be idle. Thus, overall production efficiency of the products is reduced.

Therefore, there is room for improvement in the art.

### BRIEF DESCRIPTION OF THE DRAWINGS

The components in the drawing are not drawn to scale, the emphasis instead being placed upon clearly illustrating the principles of at least one embodiment.

FIG. 1 is a schematic block diagram of a matrix production system according to an exemplary embodiment of the present disclosure.

FIG. 2 is a flowchart of one embodiment of a control method implemented by the matrix production system of FIG. 1.

### DETAILED DESCRIPTION

Reference will be made to the drawings to describe various embodiments.

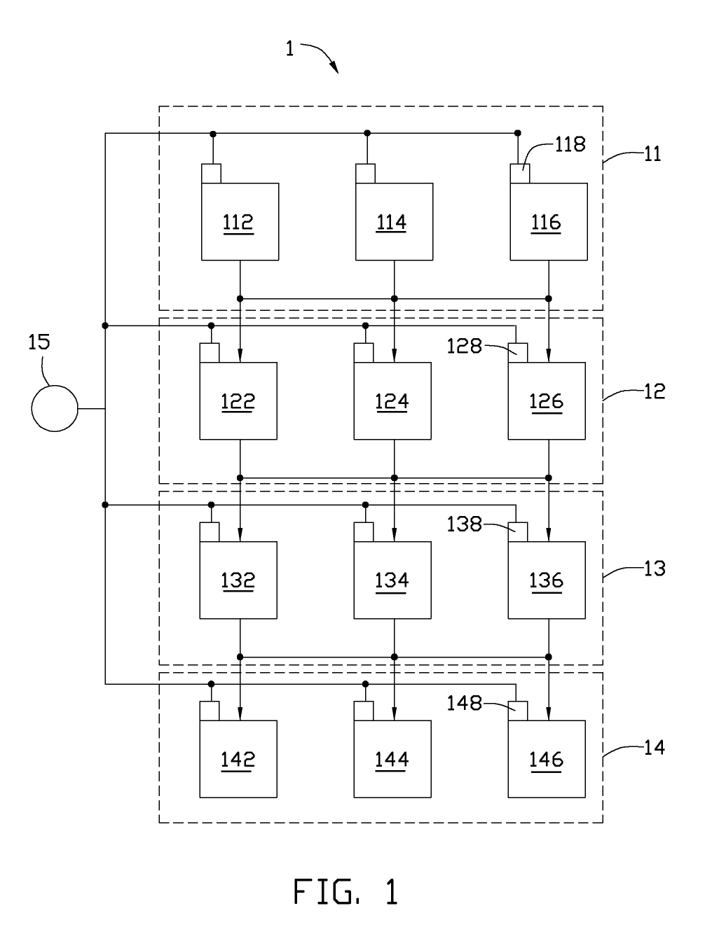

FIG. 1 illustrates a schematic block diagram of a matrix production system 1 according to an exemplary embodiment. The matrix production system 1 is a group of production lines producing a same product. The matrix production system 1 includes a controller 15, such as a computer, and a plurality of processing units 11, 12, 13, and 14. Each processing unit completes a procedure during an industrial production process to produce a product. Each processing unit includes a plurality of stations (labeled as 112, 114, 116, . . . , and 146) and a plurality of detectors (118, 128, 138, and 148), where each detector corresponds to a station. The station is defined to be a part of a production line where the production line consists of a series of stations for manufacturing determined products such as a toy, a car, or a mobile phone. In the embodiment, the station is a group of (parallel) machines or operators performing one or more operations on the production line. The processing unit is defined to be a group of a plurality of stations having same function. In the embodiment, the detector is defined to an electric device which detects a current number of workpieces received by the station such as an IR device, a computer, or a barcode device. The detector is electrically connected to a station and the controller 15. Each station, being an anterior processing unit, communicates with each station, being a posterior processing unit, in a production line. The controller 15 determines production procedures for products and a first reference capacity and a second reference capacity, which is an amount of workpieces received by each station in the processing units. Each of the detectors detects a current number of workpieces received by one station, and transmits detection data including the current number of workpieces received at the station to the controller 15. When the current number of workpieces received by one station exceeds a first reference capacity (resulting in an overburdened station), the controller 15 diverts the flow of workpieces from the overburdened station to a station which has the same function with the overburdened station.

In an exemplary embodiment, the matrix production system 1 includes a first processing unit 11, a second processing unit 12, a third processing unit 13, and a fourth processing unit 14. The first processing unit 11 works at a material feeding process of the production procedures. The second processing unit 12 works at a manufacturing process of the production procedures. The third processing unit 13 works at a testing process of the production procedures. The fourth processing unit 14 works at a process of delivering end-products of the production procedures.

The first processing unit 11 includes a first feeding station 112, a second feeding station 114, a third feeding station 116, and three first detectors 118. Each first detector 118 is located at and corresponds to one of the first, second, and third feeding stations 112, 114, and 116. The second processing unit 12 includes a first manufacture station 122, a second manufacture station 124, a third manufacture station 126, and three second detectors 128. Each second detector 128 is located at and corresponds to one of the first, second, and third manufacture stations 122, 124, and 126. The third processing unit 13 includes a first test station 132, a second test station 134, a third test station 136, and three detectors 138. Each third detector 138 is located at and corresponds to one of the first, second, and third test stations 132, 134, and 136. The fourth processing unit 14 includes a first delivery station 142, a second delivery station 144, a third delivery station 146, and three fourth detectors 148. Each fourth detector 148 is located at and corresponds to one of first, second, and third delivery stations 142, 144, and 146.

In the embodiment, each of the first detector 118, the second detector 128, the third detector 138, and the fourth detector 148 detect a current number of workpieces received by each station at regular intervals, and transmit detection data including the current number of the received workpieces to the controller 15.

The controller 15 sets a first manufacturing process in relation to the first feeding station 112, the first manufacture station 122, the first test station 132, and the first delivery station 142. The controller 15 sets a second manufacturing process in relation to the second feeding station 114, the second manufacture station 124, and the second delivery station 144. The controller 15 sets a third manufacturing process in relation to the third feeding station 116, the third manufacture station 126, and the third delivery station 146.

In the embodiment, the controller 15 sets the first reference capacity as seventy and the second reference capacity as eighty, but the disclosure is not limited thereto.

The second processing unit 12 is taken as an example in a manufacturing process. In operation, the controller 15 compares the current number of received workpieces detected by the second detector 128 with the first reference capacity to determine an overburdened station or not. When the received workpieces of a target manufacture station 122 exceeds the first reference capacity, the controller 15 detects a running state whether the target manufacture station 122 performs one operation on the production line normally by comparing the current number with the second reference capacity. In an example, it is assumed that the current number of workpieces received by the first manufacture station 122 is fifty, the current number of workpieces received by the second manufacture station 124 is seventy-five, the current number of workpieces received by the third manufacture station 126 is eighty-five, and the running state of the first manufacture station 122 and that of the second manufacture station 124 is normal. The running state of the third manufacture station 126 is malfunctioning. And then the controller 15 notifies a manager of the matrix production system 1 to repair the malfunction of the third manufacture station 126 via an email or sounding of an alarm. Then the controller 15 controls the workpieces from the third manufacture station 126 to instead flow to the first manufacture station 122. That is, the controller 15 switches the flow of workpieces from the third manufacture station 126 (the malfunctioning station) to the first manufacture station 122 (a free or idle station).

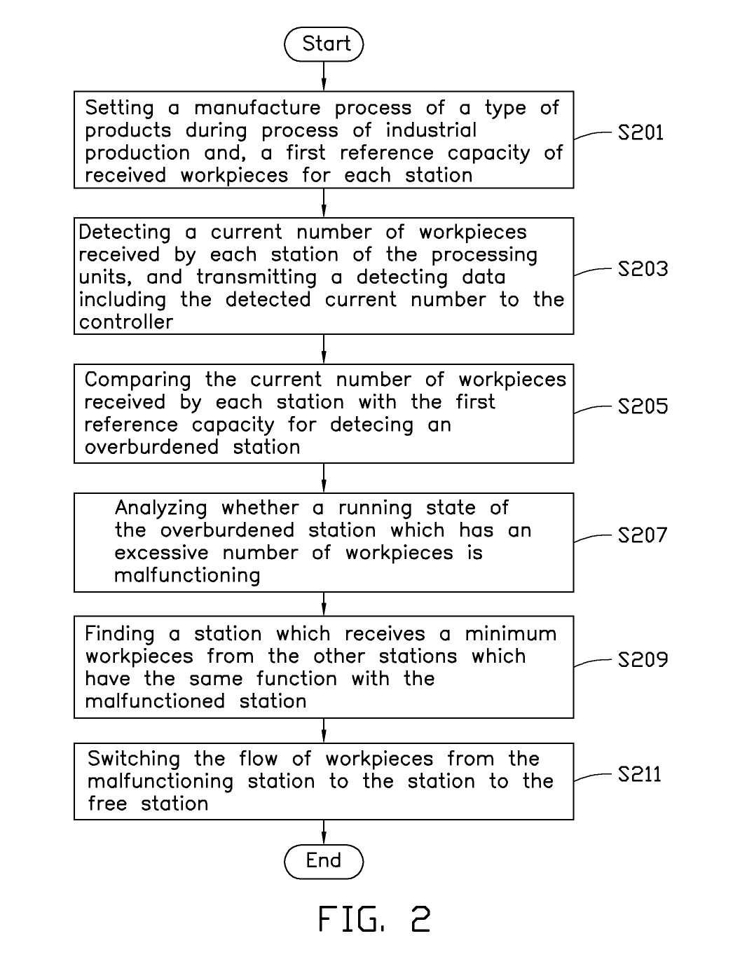

FIG. 2 shows a flowchart of one embodiment of a control method implemented by the matrix production system. The method includes the following steps, but in other embodiments, additional steps may be added, others deleted, and the ordering of the steps may be changed.

In step S201, the controller 15 sets a manufacturing process of a type of products during an industrial production process, and a first and second reference capacity of each station. In the embodiment, the second reference capacity is greater than the first reference capacity.

In step S203, each detector detects a current number of workpieces received by a station, and transmits a detection data including the detected current number to the controller 15.

In step S205, the controller 15 compares the current number detected by each detector with the first reference capacity for detecting an overburdened station. When the current number of received workpieces of one station exceeds the first reference capacity, the station is determined as the overburdened station, and step S207 is performed.

In step S207, the controller 15 analyzes whether the running state of the overburdened station which has an excessive number of workpieces is malfunctioning. In the embodiment, the controller 15 compares the current number of workpieces received by the overburdened station with the second reference capacity to obtain the running state of the overburdened station. If the number of received workpieces of the overburdened station is greater than the second reference capacity, the running state of the overburdened station is deemed to be malfunctioning. And then the controller 15 notifies a manager of the matrix production system 1 to repair the malfunction. Otherwise, if the number of received workpieces of the overburdened station is not greater than the second reference capacity, the running state of the overburdened station is deemed to be not malfunctioning.

In step S209, the controller 15 finds a station which has a free or idle capacity, in the event of there being more than one, the station which has a minimum number of workpieces from amongst all the other stations in the posterior processing unit which have the same function with the malfunctioning station.

In step S211, the controller 15 switches the flow of workpieces from the malfunctioning station to the station with free or idle capacity.

The matrix production system the switches the flow of workpieces from any malfunctioning or overburdened station to a station with available capacity, thus the overall production efficiency is improved.

It is to be understood that even though numerous characteristics and advantages of the present embodiments have been set forth in the foregoing description, together with details of the structures and functions of the embodiments, the disclosure is illustrative only; and changes may be made in detail, especially in the matters of arrangement of parts within the principles of the embodiments, to the full extent indicated by the broad general meaning of the terms in which the appended claims are expressed.

What is claimed is:

1. A control method for a matrix production system having a controller, the matrix production system comprising a plurality of processing units comprising at least one anterior processing unit and at least one posterior processing unit, each processing unit having a plurality of stations having a same function, each station being an anterior processing unit communicates with each station being a posterior processing unit in a production line, the control method comprising:
setting a manufacturing process of a type of product during an industrial production process, and a first reference capacity of received workpieces for each station;
detecting a current number of workpieces received by each station of the processing units, and transmitting the detected current number to the controller;
comparing the current number of workpieces received by each station with the first reference capacity for detecting an overburdened station;
analyzing whether a running state of the overburdened station, which has an excessive number of workpieces, is malfunctioning;
finding a station, which receives a minimum workpieces from the other stations which have a same function with the malfunctioning station; and
switching flow of workpieces from the malfunctioning station to a station which is free and has a same function with the malfunctioning station.

2. The method of claim 1, wherein when the current number of workpieces received by one station is greater than the first reference capacity, the station is detected as the overburdened station and the analyzing step is activated.

3. The method of claim 1, further comprising:
setting a second reference capacity of received workpieces for each station of the processing units, wherein the second reference capacity is greater than the first reference capacity.

4. The method of claim 2, wherein the analyzing step comprises:
comparing the current number of workpieces received by the overburdened station with the second reference capacity to obtain a running state of the station, and when the received workpieces of the overburdened station is greater than the second reference capacity, the running state of the overburdened station is determined to be malfunctioning.

5. The method of claim 4, wherein the analyzing step further comprises:
notifying a manager of the matrix production system to repair malfunction of the overburdened station, when the running state of the overburdened station is malfunctioning.

6. The method of claim 5, wherein the matrix production system further comprises a plurality of detectors connected to the controller, each detector corresponds to one of the stations, and each detector detects the current number of workpieces received by a corresponding station and transmits detection data including the detected current number to the controller.

7. A matrix production system for a production line, comprising:
a controller setting production procedures of a type of products during process of industrial production and a first reference capacity of each station;
a plurality of processing units, and each processing unit completing a production procedure and comprising a plurality of stations having a same function; and
a plurality of detectors connected to the controller, and each detector corresponds to one station, and each detector detecting a current number of workpieces received by the station;
the controller comparing the current number of received workpieces with the first reference capacity to obtain an overburdened station and then analyzing a running state of the overburdened station to obtain a malfunctioning station, the controller switching the flow of workpieces from the malfunctioning station to a station, which is free and has same function with the malfunctioning station.

8. The matrix production system of claim 7, wherein each processing unit completes a procedure during the procedures of industrial production process.

9. The matrix production system of claim 7, wherein the controller sets a second reference capacity of each station, wherein the second reference capacity is greater than the first reference capacity.

10. The matrix production system of claim 9, wherein when the current number of workpieces received by one station is greater than the first reference capacity, the controller analyzes a running state of the overburdened station exceed the first reference capacity.

11. The matrix production system of claim 10, wherein the controller compares the current number of workpieces received by the overburdened station with the second reference capacity to analyze the running state of the overburdened station, and when the current number of workpieces received by the overburdened station is greater than the second reference capacity, the running state of the overburdened station is malfunctioning.

12. The matrix production system of claim 11, wherein the controller notifies a manager of the matrix production system to repair malfunction, when the running state of the overburdened station is malfunctioned.

13. The matrix production system of claim 11, wherein the controller finds the free station which receives a minimum workpieces from the other stations which have the same function with the malfunctioning station.
